(19) United States
(12) Patent Application Publication
(10) Pub. No.: US 2021/0320616 A1
(43) Pub. Date: Oct. 14, 2021

(54) SINGLE AXIS SOLAR TRACKER ASSEMBLY

(71) Applicant: C.I. Corporation Pty Ltd, Paradise Point (AT)

(72) Inventor: Ahmed EL SAFTY, Paradise Point (AU)

(73) Assignee: C.I. Corporation Pty Ltd, Paradise Point (AU)

(21) Appl. No.: 17/271,660

(22) PCT Filed: Aug. 26, 2019
(86) PCT No.: PCT/AU2019/050900

§ 371 Date: Feb. 26, 2021

(30) Foreign Application Priority Data
Aug. 29, 2018 (AU) 2018903183

(51) Int. Cl. H02S 20/32; F24S 25/12; F24S 25/61; F24S 30/425

(52) U.S. Cl. CPC H02S 20/32; F24S 25/12; F24S 2030/115; F24S 30/425; F24S 25/61

(57) ABSTRACT

A single axis solar tracker assembly including a mount to mount the solar tracker assembly relative to a surface, a mounting assembly to mount at least one photovoltaic panel or solar thermal concentrator relative thereto, the mounting assembly attached relative to the mount about a single axis, an actuator mounting strut mounted relative to the mount and a linear actuator mounted to the actuator mounting strut and to the mounting assembly to cause movement of the mounting assembly to track a solar body in a single plane.

### TECHNICAL FIELD

The present invention relates to solar tracking assemblies and particularly to a single axis solar tracker assembly.

### BACKGROUND ART

U.S. Pat. No. 7,252,084 discloses a solar tracker and also provides a useful discussion of prior art as follows:

A solar collector collects solar radiation to produce solar cell output voltage. One type of solar collector moves with the sun, to face toward the sun as the sun changes its position during a daylight period. The elevation angle of the sun changes as the sun ascends and descends, and the horizontal angle of the sun changes with the movement of the sun from horizon to horizon. A solar tracking system adjusts an elevation angle of the solar collector and adjusts a horizontal angle of the solar collector to correspond with changes in the sun's position throughout a daylight period.

Prior to the invention, solar tracking for a solar collector was mathematically calculated. A computer program was devised to produce solar tracking for different days of the year, and for different latitude and longitude positions. The computer program controlled drive motors that moved the solar collector in a manner to track the sun.

U.S. Pat. No. 4,628,142 discloses a solar tracking system that foregoes a computer program. The system includes a cable that lengthens and shortens to move a solar collector about a horizontal axis. The cable is attached to coils of shape memory alloys that absorb solar energy. When illuminated by the sun, the coils of shape memory alloys uncoil, which lengthen the cable. When shaded from the sun, the shape memory alloys form tighter coils, which shorten the cable.

U.S. Pat. No. 4,832,001 discloses a solar collector having two solar heated canisters containing Freon. The canisters are interconnected to exchange Freon from one canister to another. When both canisters are illuminated by the sun, they absorb solar energy to evaporate the Freon to a gaseous state. When one of the canisters is shaded from the sun, the Freon in the shaded canister condenses to a liquid state, making the shaded canister containing liquid Freon heavier than the illuminated canister containing gaseous Freon. The heavier weight moves the solar collector until both canisters become illuminated by the sun, which evaporates the Freon and equalizes the canister weights.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a single axis solar tracker assembly, which may at least partially overcome at least one of the abovementioned disadvantages or provide the consumer with a useful or commercial choice.

With the foregoing in view, the present invention in one form, resides broadly in a single axis solar tracker assembly including a mount to mount the solar tracker assembly relative to a surface, a mounting assembly to mount at least one photovoltaic panel or solar thermal concentrator relative thereto, the mounting assembly attached relative to the mount about a single axis, an actuator mounting strut mounted relative to the mount and a linear actuator mounted to the actuator mounting strut and to the mounting assembly to cause movement of the mounting assembly to track a solar body in a single plane.

The single axis solar tracker of the present invention is preferably used to mount one or more photovoltaic panels or solar thermal concentrators relative thereto and to allow movement of the photovoltaic panels or solar thermal concentrators as required, to track the movement of the sun and maximise electrical or solar thermal output. In particular, the single axis solar tracker of the invention is adapted to be used to mount a number of photovoltaic panels or solar thermal concentrators relative to one another in order to allow the plurality of photovoltaic panels or solar thermal concentrators to be aligned or oriented together.

The single axis solar tracker of the present invention includes a mount to mount the tracker assembly relative to a surface. The function of the mount is not only to mount the tracker assembly relative to a surface but preferably also to maintain the solar tracker at a height relative to the surface sufficient to allow movement of the mounting assembly with photovoltaic panels or solar thermal concentrators as required.

Any type of mount may be used. The particular configuration of mount used will typically depend upon the location of the assembly and more particularly, to the surface relative to which the assembly is to be located. Normally, the assembly will be mounted on a ground surface. The mount preferred in that situation will therefore normally be provided to space the at least one photovoltaic panel or solar thermal concentrator above the ground surface to allow pivoting of the panels or solar thermal concentrators about a single axis in order to track a solar body such as the sun.

Preferably, the mount will include a number of uprights extending from a ground support, with the mounting assembly used to mount the at least one photovoltaic panel or solar thermal concentrator, provided relative to the upper end of the uprights. Normally, the ground support will take the form of a base rail relative to which the number of uprights are located, and typically, the uprights will be directly attached to the base rail.

The base rail will preferably include at least one, and normally a number of elongate members attached to each other end to end. It is preferred that the base rail is substantially linear. In use, the base rail will typically be located directly on the ground surface but there may be intervening members in order to level the base rail for example.

The base rail members are each preferably formed as an extruded member in order to provide a consistent profile over the length of the base rail.

The configuration of the preferred extrusion for the base rail will preferably allow transverse or cross members to be attached relative thereto as well as to allow the uprights to be attached to the base rail.

The transverse members or cross members will preferably extend substantially perpendicularly to the base rail. Preferably, each of the transverse members or cross members will also be extruded and will typically have the same configuration as the preferred extrusion used for the base rail. Normally, at least one transverse member or cross member will extend on each lateral side of the base rail. The transverse members will typically be mounted relative to the base rail such that a lower surface of the base rail and the transverse members or cross members will be coplanar in order to form a frame to support the assembly relative to the surface.

Normally, the transverse members or cross members will be spaced over the length of the base rail, normally equally spaced but the spacing can vary depending upon the ground conditions. Equally, the provision of the particular configuration of extrusion used will preferably allow the transverse members or cross members to be moved relative to the base rail relatively easily to adjust the position of the transverse members or cross members.

The uprights will normally be spaced over the length of the base rail. The uprights will typically be substantially vertically extending. This may not mean that the uprights necessarily extend approximately perpendicularly from the base rail, but normally, the solar tracker assembly according to the present invention will be placed on relatively flat ground and generally speaking, the uprights will be approximately perpendicularly extending from the base rail.

Each of the uprights will typically be braced relative to the base rail through the provision of at least one, and typically a number of bracing members or structures. Normally, the uprights will be braced in a number of directions, typically at least four directions, with a bracing member or structure extending between the upright and the base rail on either side of the upright and between the upright and the transverse members cross members. Typically, the transverse members or cross members and the upright will extend from the base rail at approximately the same position such that they can each be braced against the other. The bracing is provided to maintain the upright in the desired position under load.

The upper end of each of the uprights will typically have a support mechanism for an axis rod associated with the at least one photovoltaic panel or solar thermal concentrator mounting assembly. In a preferred form, the support mechanism will include a bearing located at an upper end of each of the uprights. Preferably, the bearing will take the form of a bearing block, preferably a Plummer bearing block which typically houses an annular bearing to allow the axis rod to rotate freely relative to the upright (the rotation of the axis rod will typically be controlled by the linear actuator).

Preferably, each upright may be provided with a transversely extending head member relative to which the preferred bearing block is mounted. The head member will typically extend transversely to the base rail, and generally parallel to the plane of the transverse members or cross members. Typically, a single head member is provided relative to the upper end of each upright, and the head member will preferably have the same cross-sectional configuration as the base rail and the transverse members or cross members, namely it will generally be formed from an extrusion of the same cross-sectional configuration.

Bracing will typically be provided between the transversely extending head member and the upright. A bracing member or structure will typically be provided on either side of the upright in order to brace the head member against movement. In the preferred form, the head member and the upright will have the same configuration and be substantially aligned, which means that bracing need only be provided in one direction rather than in two directions.

The single axis solar tracker of the present invention includes a mounting assembly to mount at least one photovoltaic panel or solar thermal concentrator relative thereto. The mounting assembly will typically hold generally at least one planar photovoltaic panel or solar thermal concentrator and could be used to hold more than one photovoltaic panel or solar thermal concentrator. Clearly it is important that the mounting assembly hold the at least one photovoltaic panel or solar thermal concentrator securely through movement of the solar tracker. It is also important to recognise that the solar tracker may function in harsh conditions and therefore, the photovoltaic panel(s) or solar thermal concentrator(s) will be securely mounted to the mounting assembly.

The preferred mounting assembly includes a pair of elongate support rails in order to support at least one photovoltaic panel or solar thermal concentrator relative thereto. The support rails are preferably spaced from one another and extend substantially parallel to one another. The support rails will normally support the photovoltaic panels by extending centrally across the at least one of the photovoltaic panels or solar thermal concentrators. The support rails will normally be substantially parallel to the base rail.

The support rails will preferably be rectangular in cross-sectional shape and a support surface of each of the support rails will preferably be substantially coplanar in order to abut a rear surface of the at least one photovoltaic panel or solar thermal concentrator.

Typically, each assembly will have a pair of support rails which are formed from more than one support member. In a preferred embodiment, 3 support rail members of approximately 5 m to 7 m in length are used attached end to end to form each of the support rails.

At least one, and typically a number of perpendicular rails will be provided extending between the preferred pair of elongate support rails in order to maintain the support rails in a spaced apart condition and to form a frame to be used to support the at least one photovoltaic panel or solar thermal concentrator. The perpendicular rails will also typically mount the preferred Axis rod, generally proximally centrally across the length of the perpendicular rails.

The perpendicular rails are typically attached directly to the support rails. Preferably, the perpendicular rails have a support surface which is aligned to be coplanar with the support surface of the support rails in order to assist with the support of the at least one photovoltaic panel or solar thermal concentrator.

A number of perpendicular rails will typically be spaced over the length of the support rails. It is not necessary that a perpendicular rail be provided to support each at least one photovoltaic panel or solar thermal concentrator. In a preferred configuration, four perpendicular rails are provided over the length of a support rail member. In the preferred embodiment, this will mean that 12 perpendicular rails are provided over a mounting assembly formed from three support rail members end to end. In this configuration, the mounting assembly will typically mount 18 photovoltaic panels or a corresponding number of solar thermal concentrators.

Preferably, the photovoltaic panels or solar thermal concentrators will be attached or mounted directly to the support rails and if possible, one or more perpendicular rails. Normally fasteners are used to attach the panels directly to the rails and typically, threaded fasteners are used. However, any fastening methodology may be used including clips or clamps or the like.

The preferred axis rod will typically be centrally mounted over the height of the perpendicular rails in order to locate the axis rod substantially centrally along the support frame. Each of the perpendicular rails will typically have a pipe clamp lug shaped to mount a substantially cylindrical axis rod relative to an underside of the perpendicular rails. In a preferred form, the pipe clamp lug has a pair of spaced apart flanges with an arcuate rod receiver portion located there between. The spaced apart flanges are generally attached directly to the perpendicular rails and any method may be used.

Any material of construction can be used but it is preferred that the support rails are formed from an extrusion, preferably the same extrusion as that used for the base rail and transverse members and uprights.

The single axis solar tracker assembly of the present invention includes an actuator mounting strut mounted relative to the mount. Normally, the actuator mounting strut is provided between two spaced apart uprights. In a preferred embodiment, a single linear actuator is provided for a bank of solar panels or solar thermal concentrators. In a particularly preferred embodiment, a single linear actuator can be used according to the present invention for as many as 18 solar panels mounted relative to a mounting assembly which is some 18 m in length.

Typically, there are a number of uprights provided in the tracker assembly of the present invention, generally 6 uprights with one spaced every approximately 3 meters. Normally, the actuator mounting strut will be mounted between two centrally located uprights. In the preferred embodiment, the mounting strut will be mounted to one side of the centre of the assembly but positioned to allow the linear actuator to be provided as centrally as possible over the length of the tracker assembly.

The actuator mounting strut of the present invention is typically mounted between two uprights substantially parallel to the support rails and to the base rail. The actuator mounting strut is typically spaced between the base rail and the axis rod of the assembly, normally below the preferred transverse head member and above any bracing provided to brace the upright into position.

A mounting plate or member preferably extends laterally from the actuator mounting strut in order to mount the linear actuator relative to the actuator mounting strut. Preferably, the mounting plate or member extends in a direction substantially parallel to the transverse members or cross members of the assembly.

An actuator mount is typically provided at an outer, free end of the mounting plate or member. Preferably, the actuator mount is positioned and configured to mount a slew drive or linear actuator or similar (the term “linear actuator” is used in a representative manner in this specification) at an angle to the actuator mounting strut. The actuator mount may mount the linear actuator in a fixed position or alternatively, allow the linear actuator to pivot relative to the mount.

In a preferred form, the linear actuator extends and retracts relative to a fixed point and through the extension and retraction of the linear actuator, the mounting assembly for the at least one photovoltaic panel or solar thermal concentrator, is rotated about the axis rod.

As mentioned above, the linear actuator is typically mounted relative to the actuator mounting strut as close as possible to the midpoint of the solar tracker assembly but slightly to one side of the midpoint as this will allow the minimisation of torque created in the frame assembly supporting the at least one photovoltaic panel or solar thermal concentrator, as much as possible.

The single axis solar tracker assembly of the present invention includes a linear actuator mounted pivotally to the actuator mounting strut and to the mounting assembly to cause movement of the mounting assembly to track a solar body in a single plane. As mentioned above, extension and retraction of the linear actuator typically drives movement of the mounting assembly, and thereby movement of the at least one photovoltaic panel or solar thermal concentrator about a single axis which is preferably defined by the preferred axis rod.

The linear actuator may be pivotally mounted relative to the mounting assembly. Preferably, one end of the linear actuator is mounted relative to one of the members of the mounting assembly frame and a portion of the linear actuator is mounted relative to the mounting strut. Preferably, an outer end of the linear actuator is mounted relative to a support rail of the mounting assembly. A mounting plate or member may be provided attached to the mounting assembly in order to mount the outer end of the linear actuator.

Any type of linear actuator may be used and the linear actuator may be driven using any energy source. Typically, a portion of the energy collected by the at least one photovoltaic panel or solar thermal concentrator is converted to electricity to be used to power the linear actuator. As mentioned above, extension and retraction of the linear actuator (preferably controlled by a control mechanism) will cause rotation of the mounting assembly about the preferred axis rod in order to track the movement of the sun in a single axis.

The control mechanism may take any form and any one of a variety of different conventional control mechanisms could be used.

Most, if not all of the main structural members used in the assembly of the present invention will be formed from an elongate member, typically of the same cross-section. For example, it is preferred that the base rail, the transverse members or cross members the uprights the preferred head member at the upper end of the uprights, the support rails and the perpendicular rails are all formed from an elongate member of the same cross-section. This allows the members of the assembly to be uniform.

The elongate member may be formed using any method but extrusion, pultrusion and similar methods are preferred for their ability to give an elongate member a consistent cross section over length. In the present specification, use of “extrusion” is intended to cover an elongate member formed using any appropriate method

It is preferred that the extrusion have an external dimension of approximately 90 mm×45 mm although the extrusion can be used in either the long dimension or the short dimension depending upon the position in the assembly.

The extrusion is typically hollow which will provide a lower weight but with relatively high strength. It is preferred that extrusion before from a metal material and aluminium or similar alloy is particularly preferred for robustness and usable life in external, possibly adverse conditions.

It is preferred that the extrusion have 2 openings on each long side and one opening on each short side. Preferably, the openings have a pair of opposed, planar flange is defining the entry to the openings which will typically allow clamping formations to be used.

According to the present invention, a single axis solar tracker assembly is provided relative to which multiple photovoltaic panels or solar thermal concentrators are provided to allow the photovoltaic panels or solar thermal concentrators to be moved together, easily with a minimal power draw through the provision of a single linear actuator for multiple photovoltaic panels or solar thermal concentrator.

Any of the features described herein can be combined in any combination with any one or more of the other features described herein within the scope of the invention.

The reference to any prior art in this specification is not, and should not be taken as an acknowledgment or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an elevation view of a single axis solar tracker assembly according to a preferred embodiment of the present invention.

FIG. 2 is an isometric view of the solar tracking assembly illustrated in FIG. 1.

FIG. 2A is a detail view of the portion illustrated in FIG. 2.

FIG. 3 is a section view of the solar tracking assembly illustrated in FIG. 1 taken along line G-G.

FIG. 3A is a detail view of the portion illustrated in FIG. 3.

FIG. 4 is a detail view of the portion illustrated in FIG. 1 and identified using reference letter A.

FIG. 5 is a detail view of the portion illustrated in FIG. 1 and identified using reference letter B.

FIG. 6 is an isometric partially exploded view of the solar tracking assembly illustrated in FIG. 2.

FIG. 6A is a detail view of the portion illustrated in FIG. 6.

FIG. 6B is a sectional view of an extrusion used for many components of the solar tracker assembly of the preferred embodiment.

FIG. 7 is an exploded end elevation view of the solar tracker assembly illustrated in FIG. 6.

### DESCRIPTION OF EMBODIMENTS

According to a particularly preferred embodiment of the present invention, a single axis solar tracker assembly 10 is provided.

The single axis solar tracker assembly 10 of the preferred embodiment illustrated in the Figures includes a mount 11 to mount the solar tracker assembly 10 relative to a surface, a mounting assembly 12 to mount a number of photovoltaic panels 13 or solar thermal concentrator relative thereto. The mounting assembly 12 is attached relative to the mount 11 for movement about a single axis. An actuator mounting strut 14 is mounted relative to the mount 11 and a linear actuator 15 is mounted to the actuator mounting strut 14 and to the mounting assembly 12 to cause movement of the mounting assembly 12 to track the sun in a single plane.

As illustrated, the single axis solar tracker assembly 10 is used to mount a number of photovoltaic panels 13 or solar thermal concentrators relative thereto and to allow movement of the photovoltaic panels 13 or solar thermal concentrators as required to track the movement of the sun and maximise electrical or solar thermal output. In particular, the single axis solar tracker of the invention is adapted to be used to mount a number of photovoltaic panels 13 or solar thermal concentrators to or relative to one another in order to allow the plurality of photovoltaic panels 13 or solar thermal concentrators to be aligned or oriented all at once.

The function of the mount 11 is not only to mount the tracker assembly 10 relative to a surface but preferably also to maintain the solar tracker at a height sufficient relative to the surface to allow movement of the mounting assembly 11 with photovoltaic panels 13 or solar thermal concentrators as required.

Any type of mount may be used. The particular configuration of mount used will typically depend upon the location of the assembly and more particularly, to the surface relative to which the assembly is to be located. Normally, the assembly will be mounted on a ground surface. The mount preferred in that situation will therefore normally be provided to space the at least one photovoltaic panel or solar thermal concentrator above the ground surface to allow pivoting of the panels or solar thermal concentrators about a single axis in order to track a solar body.

In the preferred embodiment illustrated, the mount 11 includes a number of uprights 16 extending from a ground support with the mounting assembly 12 used to mount the photovoltaic panels 13 or solar thermal concentrator provided relative to the upper end of the uprights 16. Normally, the ground support will take the form of a base rail 17 relative to which the number of uprights 16 are located, and in the illustrated embodiment, the uprights 16 are directly attached to the base rail 17 through the use of bolts 18, nuts 19 and washers 20.

The base rail 17 includes a number of elongate members attached to each other end to end. In use, the base rail 17 will typically be located directly on the ground surface but there may be intervening members in order to level the base rail for example.

The elongate members of the base rail 17 are preferably formed as extruded members in order to provide a consistent profile over the length of the base rail 17.

The configuration of the preferred extrusion for the base rail will preferably allow transverse or cross members 21 to be attached relative thereto as well as to allow the uprights 16 to be attached to the base rail 17.

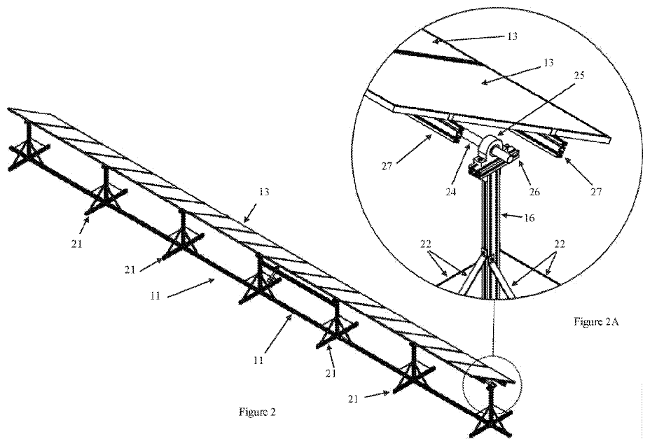

The transverse members or cross members 21 extend substantially perpendicularly to the base rail 17. Preferably, each of the transverse members or cross members 21 will also be extruded and will typically have the same configuration as the preferred extrusion used for the base rail 17. Normally, a transverse member or cross member 21 extends on each lateral side of the base rail 17 as shown in FIG. 2. The transverse members 21 are mounted relative to the base rail 17 such that a lower surface of the base rail 17 and the transverse members or cross members 21 is coplanar in order to form a frame to support the assembly 10 relative to the surface.

Normally, the transverse members or cross members 21 are equally spaced over the length of the base rail 17. Equally, the provision of the particular configuration of extrusion used will preferably allow the transverse members or cross members 21 to be moved relative to the base rail 17 relatively easily to adjust the position of the transverse members or cross members 21.

The uprights 16 are spaced over the length of the base rail 17. As illustrated, the uprights 16 are substantially vertically extending. This may not mean that the uprights necessarily extend approximately perpendicularly from the base rail, but normally, the solar tracker assemblies according to the present invention will be placed on relatively flat ground and generally speaking, the uprights will be approximately perpendicularly extending from the base rail.

Each of the uprights 16 is braced relative to the base rail 17 through the provision of a number of bracing members or structures 22. Normally, the uprights will be braced in a number of directions, typically at least 4 directions with a bracing member or structure 22 extending between the upright 16 and the base rail 17 on either side of the upright 16 and between the upright 16 and the transverse members or cross members 21. Typically, the transverse members or cross members 21 and the upright 16 will extend from the base rail at approximately the same position such that they can each be braced against each other. The bracing is provided to maintain the upright in the desired position under load. Corner brackets 23 are also provided at the lower end of the uprights 16.

The upper end of each of the uprights 16 is provided with a support mechanism for an axis rod 24 associated with the photovoltaic panel or solar thermal concentrator mounting assembly 12. In a preferred form, the support mechanism includes a bearing 25 located at an upper end of each of the uprights 16. Preferably, the bearing will take the form of a bearing block, preferably a split bearing block or a Plummer bearing block which typically houses an annular bearing to allow the axis rod 24 to rotate freely relative to the upright 16 (the rotation of the axis rod 24 will typically be controlled by the linear actuator 15).

In the illustrated embodiment, each upright 16 is provided with a transversely extending head member 26 relative to which the bearing 25 is mounted. The head member 26 extends transversely to the base rail 17, and generally parallel to the plane of the transverse members or cross members 21. The head member 26 has the same cross-sectional configuration as the base rail 17 and the transverse members or cross members 21, namely it will generally be formed from an extrusion of the same cross-sectional configuration.

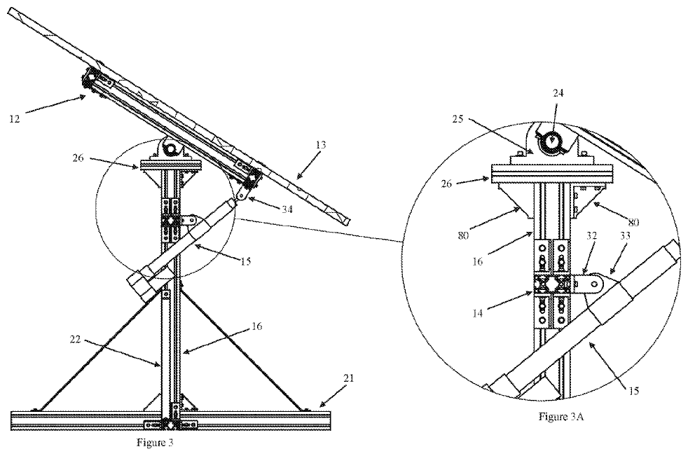

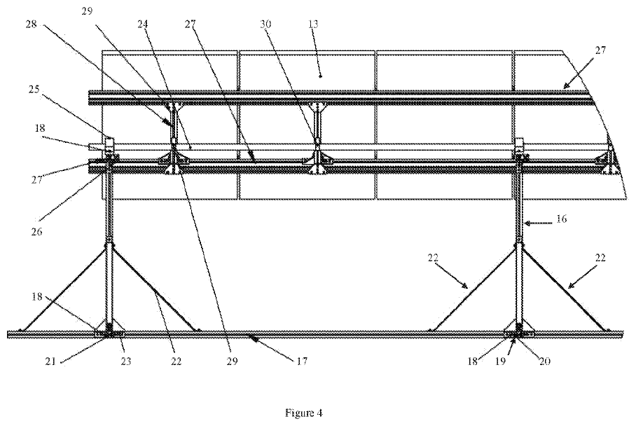

Bracing 80 is provided between the transversely extending head member 26 and the upright 16. As illustrated in FIG. 3A in particular, a bracing member or structure is provided on either side of the upright 16 in order to brace the head member against movement. In the preferred form, the head member 26 and the upright 16 have the same configuration and are substantially aligned which means that bracing 80 need only be provided in one direction rather than in two directions.

The single axis solar tracker of the present invention includes a mounting assembly to mount at least one photovoltaic panel or solar thermal concentrator relative thereto. The mounting assembly 12 will typically hold more than one photovoltaic panel 13 or solar thermal concentrator. Clearly it is important that the mounting assembly 12 hold the photovoltaic panels or solar thermal concentrators securely through movement of the solar tracker. It is also important to recognise that the solar tracker may function in harsh conditions and therefore, the photovoltaic panel(s) or solar thermal concentrator(s) will be securely mounted to the mounting assembly.

The preferred mounting assembly 12 includes a mounting frame including pair of elongate support rails 27 in order to support the photovoltaic panels or solar thermal concentrator relative thereto. The support rails 27 are spaced from one another and extend substantially parallel to one another. The support rails 27 will normally support the panels 13 by extending centrally across the photovoltaic panels 13 or solar thermal concentrators. The support rails 27 will normally be substantially parallel to the base rail 17 and remain parallel during movement.

The support rails 27 are rectangular in cross-sectional shape and a support surface of each of the support rails 27 is substantially coplanar in order to abut a rear surface of the photovoltaic panels 13.

Typically, the mounting assembly 12 has a pair of support rails 27 formed from more than one support member. In a preferred embodiment, three support rail members of approximately 5 m to 7 m in length are used attached end to end to form each of the support rails 27.

A number of perpendicular rails 28 are provided extending between the pair of elongate support rails 27 in order to maintain the support rails 27 in a spaced apart condition and to form a frame to be used to support the photovoltaic panels 13 or solar thermal concentrator. The perpendicular rails 27 will also mount the preferred Axis rod 24, generally approximately centrally across the length of the perpendicular rails 28, using a lug 30 or similar.

The perpendicular rails 28 are typically attached directly to the support rails 27 and have a support surface which is aligned to be coplanar with the support surface of the support rails 27 in order to assist with the support of photovoltaic panels 13 or solar thermal concentrator. Again, bracing 29 is provided between the perpendicular rails 28 and support rails 27.

A number of perpendicular rails 28 are spaced over the length of the support rails 27. It is not necessary that a perpendicular rail 28 be provided to support each photovoltaic panel 13 or solar thermal concentrator. In a preferred configuration, four perpendicular rails 28 are provided over the length of a support rail member. In the preferred embodiment illustrated, this will mean that 12 perpendicular rails 28 are provided over a mounting assembly 12 formed from three support rail members end to end. In this configuration, the mounting assembly 12 will typically mount 18 photovoltaic panels 13 or a corresponding number of solar thermal concentrators.

The photovoltaic panels 13 illustrated are attached or mounted directly to the support rails 27 and if possible, one or more perpendicular rails 28. Normally threaded fasteners 31 are used to attach the panels 13 directly to the rails 27, 28. However, any fastening methodology may be used including clips or clamps or the like.

The preferred axis rod 24 will typically be centrally mounted over the height of the perpendicular rails 28 in order to locate the axis rod 24 substantially centrally along the support frame. Each of the perpendicular rails 28 will typically have a pipe clamp lug 30 shaped to mount a substantially cylindrical axis rod 24 relative to an underside of the perpendicular rails 28. In a preferred form, the pipe clamp lug 30 has a pair of spaced apart flanges with an arcuate rod receiver portion located there between. The spaced apart flanges are generally attached directly to the perpendicular rails 28 and any method may be used.

Any material of construction can be used but it is preferred that the support rails 27 are formed from an extrusion, preferably the same as that used for the base rail 17 and transverse members 21 and uprights 16.

The single axis solar tracker assembly of the present invention includes an actuator mounting strut 14 mounted relative to the mount. Normally, the actuator mounting strut 14 is provided between two spaced apart uprights 16. In a preferred embodiment, a single linear actuator 15 is provided for a bank of solar panels 13 or solar thermal concentrators. In a particularly preferred embodiment, a single linear actuator 15 can be used for as many as 18 solar panels 13 mounted relative to a mounting assembly 12 which is some 18 m in length.

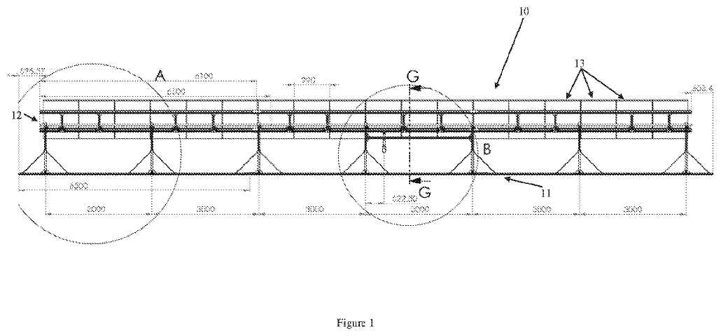

Typically, there are a number of uprights 16 provided in the tracker assembly of the present invention, generally 6 uprights 16 with one spaced every approximately 3 meters. Normally, the actuator mounting strut 14 will be mounted between two centrally located uprights as illustrated in FIG. 1. In the preferred embodiment, the mounting strut 14 will be mounted to one side of the centre of the assembly 10 but position to allow the linear actuator 15 to be provided as centrally as possible over the length of the tracker assembly 10.

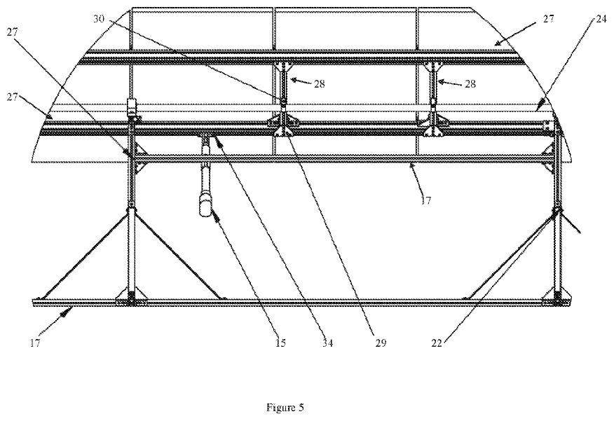

The actuator mounting strut 14 is mounted between two uprights substantially parallel to the support rails 27 and to the base rail 17. The actuator mounting strut 14 is typically spaced between the base rail 17 and the Axis rod 24 of the assembly, normally below the transverse head member 26 and above any bracing 22 provided to brace the upright 16 into position in a position as shown in FIG. 5.

A mounting plate or member 32 extends laterally from the actuator mounting strut 14 in order to mount the linear actuator 15 relative to the actuator mounting strut 14. Preferably, the mounting plate or member 32 extends in a direction substantially parallel to the transverse members or cross members 21 of the assembly.

An actuator mount is typically provided at an outer, free end of the mounting plate or member 32 to engage with the mount 33 of the actuator 15 to mount the linear actuator 15 at an angle to the actuator mounting strut 32. The actuator mount 33 may mount the linear actuator 15 in a fixed position or alternatively, allow the linear actuator 15 to pivot relative to the mount 33.

In a preferred form, the linear actuator 15 extends and retracts relative to a fixed point and through the extension and retraction of the linear actuator 15, the mounting assembly 12 for the photovoltaic panel 13 is rotated about the axis rod 24.

As mentioned above, the linear actuator 15 is mounted relative to the actuator mounting strut 14 as close as possible to the midpoint of the solar tracker assembly 10 but slightly to one side of the midpoint as this will allow the minimisation of torque created in the frame assembly supporting the photovoltaic panel 13, as much as possible.

As mentioned above, extension and retraction of the linear actuator 15 typically drives movement of the mounting assembly 12, and thereby movement of the photovoltaic panel 13 or solar thermal concentrator about a single axis which defined by the preferred axis rod 24.

The linear actuator 15 may be pivotally mounted relative to the mounting assembly 12. One end of the linear actuator 15 is mounted relative to one of the members of the mounting assembly frame and a portion of the linear actuator 15 is mounted relative to the mounting strut 14. Preferably, an outer end of the linear actuator 15 is mounted relative to a support rail 27 of the mounting assembly 12. A mounting plate or member 34 is provided attached to the mounting assembly 12 in order to mount the outer end of the linear actuator 15.

Any type of linear actuator 15 may be used and the linear actuator 15 may be driven using any energy source. Typically, a portion of the energy collected by the at least one photovoltaic panel or solar thermal concentrator is converted to electricity to be used to power the linear actuator. As mentioned above, extension and retraction of the linear actuator (preferably controlled by a control mechanism) will cause rotation of the mounting assembly about the preferred axis rod in order to track the movement of the sun in a single axis.

The control mechanism may take any form and any one of a variety of different conventional control mechanisms could be used.

Most, if not all of the main structural members used in the assembly are preferably formed from an extrusion, typically an extrusion of the same cross-section. For example, it is preferred that the base rail 17, the transverse members or crossmembers 21, the uprights 16, the preferred head member 26 at the upper end of the uprights 16, the support rails 27 and the perpendicular rails 28 are all formed from an extrusion of the same cross-section. This allows the members of the assembly to be uniform.

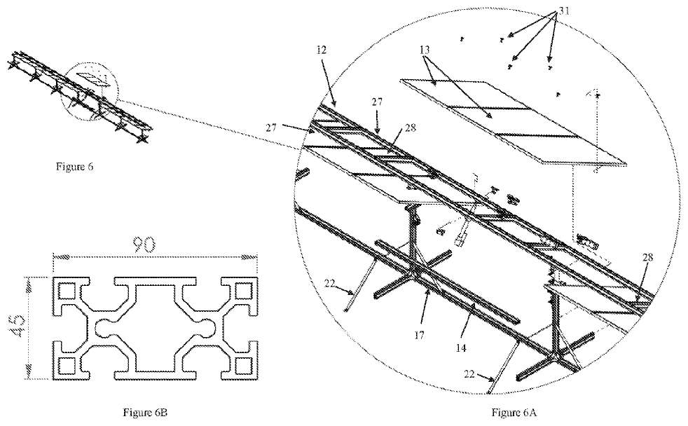

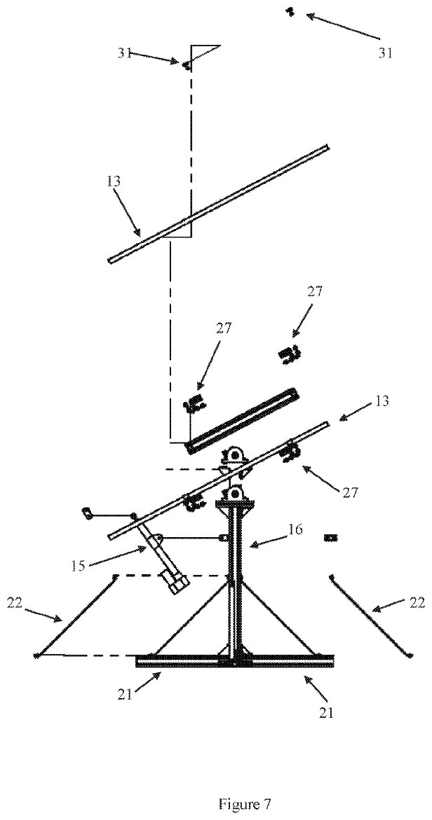

An extrusion as illustrated in FIG. 6A is particularly preferred. It is preferred that the extrusion have an external dimension of approximately 90 mm×45 mm although the extrusion can be used in either the long dimension or the short dimension depending upon the position in the assembly.

The extrusion is typically hollow which will provide a lower weight but with relatively high strength. It is preferred that extrusion before from a metal material and aluminium or similar alloy is particularly preferred for robustness and usable life in external, possibly adverse conditions.

It is preferred that the extrusion have two openings on each long side and one opening on each short side. Preferably, the openings have a pair of opposed, planar flange is defining the entry to the openings which will typically allow clamping formations to be used.

According to the present invention, a single axis solar tracker assembly is provided relative to which multiple photovoltaic panels or solar thermal concentrators are provided to allow the photovoltaic panels or solar thermal concentrators to be moved together, easily with a minimal power draw through the provision of a single linear actuator for multiple photovoltaic panels or solar thermal concentrator.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A single axis solar tracker assembly including:
a mount to mount the solar tracker assembly relative to a surface,
a mounting assembly to mount at least one photovoltaic panel or solar thermal concentrator relative thereto, the mounting assembly attached relative to the mount about a single axis,
an actuator mounting strut mounted relative to the mount, and
a linear actuator mounted to the actuator mounting strut and to the mounting assembly to cause movement of the mounting assembly to track a solar body in a single plane.

2. The single axis solar tracker assembly as claimed in claim 1, wherein the mount includes a number of uprights extending from a ground support, with the mounting assembly used to mount at least one photovoltaic panel or solar thermal concentrator, provided relative to the upper end of the uprights.

3. The single axis solar tracker assembly as claimed in claim 2, wherein the ground support is in the form of a base rail relative to which the number of uprights are located.

4. The single axis solar tracker assembly as claimed in claim 3, wherein the base rail includes a number of elongate members attached to each other end to end.

5. The single axis solar tracker assembly as claimed in claim 4, wherein the base rail members are each formed as an extruded member.

6. The single axis solar tracker assembly as claimed in claim 5, wherein each extruded member is configured to allow transverse members or cross members to be attached relative thereto as well as to allow the uprights to be attached to the base rail.

7. The single axis solar tracker assembly as claimed in claim 6, wherein the transverse members or cross members extend substantially perpendicularly to the base rail.

8. The single axis solar tracker assembly as claimed in claim 5, wherein each of the transverse members or cross members are extruded and have the same configuration as the extrusion used for the base rail.

9. The single axis solar tracker assembly as claimed in claim 7, wherein the transverse members are mounted relative to the base rail such that a lower surface of the base rail and the transverse members or cross members are coplanar in order to form a frame to support the assembly relative to the surface.

10. The single axis solar tracker assembly as claimed in claim 2, wherein the uprights are spaced over the length of the base rail.

11. The single axis solar tracker assembly as claimed in claim 6, wherein the transverse members or cross members and the uprights extends from the base rail at approximately the same position such that they can each be braced against the other.

12. The single axis solar tracker assembly as claimed in claim 2, wherein an upper end of each upright includes a support mechanism for an axis rod associated with the mounting assembly.

13. The single axis solar tracker assembly as claimed in claim 12, wherein the support mechanism includes a bearing located at an upper end of each of the uprights.

14. The single axis solar tracker assembly as claimed in claim 13, wherein each upright includes a transversely extending head member relative to which the bearing is mounted.

15. The single axis solar tracker assembly as claimed in claim 1, wherein the mounting assembly includes a pair of elongate support rails in order to support at least one photovoltaic panel or solar thermal concentrator relative thereto.

16. The single axis solar tracker assembly as claimed in claim 15, wherein mounting assembly further includes a number of perpendicular rails extending between the preferred pair of elongate support rails.

17. The single axis solar tracker assembly as claimed in claim 16, wherein the number of perpendicular rails mount an axis rod.

18. The single axis solar tracker assembly as claimed in claim 17, wherein the axis rod is centrally mounted over the height of the perpendicular rails.

19. The single axis solar tracker assembly as claimed in claim 2, wherein the actuator mounting strut is provided between two of the number of uprights which are spaced apart.

20. The single axis solar tracker assembly as claimed in claim 1, wherein a mounting plate or member extends laterally from the actuator mounting strut in order to mount the linear actuator relative to the actuator mounting strut.

21-22. (canceled)
